(19) United States
(12) Patent Application Publication
(10) Pub. No.: US 2019/0180667 A1
(43) Pub. Date: Jun. 13, 2019

(54) PIXEL CIRCUIT AND DISPLAY DEVICE

(71) Applicant: AU OPTRONICS CORPORATION, Hsin-Chu (TW)

(72) Inventors: Wu-Wei Lin, Hsin-Chu (TW); Jui-Chi Lo, Hsin-Chu (TW)

(21) Appl. No.: 16/211,417

(22) Filed: Dec. 6, 2018

(30) Foreign Application Priority Data
Dec. 7, 2017 (TW) 106143013

(51) Int. Cl. G09G 3/20

(52) U.S. Cl. CPC G09G 3/20; G09G 2310/0297; G09G 2300/0809; G09G 2360/14

(57) ABSTRACT

A pixel circuit includes one or more storage capacitors, one or more first switches, a light sensing component, a second switch, and a third switch. The first switches are electrically connected to the storage capacitors, and configured to provide a data voltage to the storage capacitors according to a gate signal. The second switch is electrically connected to the light sensing component, and configured to output an output signal according to a sensing voltage. The third switch is electrically connected to the light sensing component, and configured to provide a reset voltage to the light sensing component according to a reset control signal.

### RELATED APPLICATIONS

This application claims priority to Taiwan Application Serial Number 106143013, filed Dec. 7, 2017, which is herein incorporated by reference.

### BACKGROUND

### Technical Field

The present disclosure relates to an electronic circuit. More particularly, the present disclosure relates to a pixel circuit.

### Description of Related Art

With advances in electronic technology, display devices, such as mobile phones or computers, have been widely used in people's lives.

In some applications, display devices may have light sensing function for performing operations such as image recognition. However, disposing a light sensing circuit in a pixel array of a display device makes the operation of the display device be more complicated and decreases the aperture ratio of the display device, thereby affecting display quality.

Therefore, how to design a display device with light sensing function is an important research aspect of this field.

### SUMMARY

One aspect of the present disclosure is related to a pixel circuit. In accordance with one embodiment of the present disclosure, the pixel circuit includes one or more storage capacitors, one or more first switches, a light sensing component, a second switch, and a third switch. The first switches are electrically connected to the storage capacitors and configured to provide a data voltage to the storage capacitor according to a gate signal. The light sensing component generates a sensing voltage according to a light sensing procedure. The second switch is electrically connected to the light sensing component and configured to output a sensing output signal according to the sensing voltage. The third switch is electrically connected to the light sensing component and configured to provide a reset voltage to the light sensing component according to a reset control signal.

Another aspect of the present disclosure is related to a pixel circuit. In accordance with one embodiment of the present disclosure, the pixel circuit includes one or more storage capacitors, one or more data lines, one or more first switches, a light sensing component, a second switch, and a third switch. One or more first end of one or more first switches are electrically connected to one or more data lines, one or more second end of one or more first switches are electrically connected to one or more storage capacitors, and one or more control end of the one or more first switches are configured to receive a gate signal. A first end of the second switch is electrically connected to an anode end of the light sensing component, a second end of the second switch is configured to receive a reset voltage, and a control end of the second switch is configured to receive a reset control voltage. A first end of the third switch is electrically connected to a readout line, a control end of the third switch is electrically connected to the anode end of the light sensing component, and the third switch is configured to output a sensing output signal via the readout line according to a sensing voltage on the anode end of the light sensing component.

Through the application of one embodiment described above, the display operation of the pixel circuit can be integrated with the light sensing operation of the pixel circuit.

### BRIEF DESCRIPTION OF THE DRAWINGS

The invention can be more fully understood by reading the following detailed description of the embodiments, with reference made to the accompanying drawings as follows:

FIG. 1 illustrates a schematic diagram of a display device in accordance with one embodiment of the present disclosure.

FIG. 2 illustrates a schematic diagram of a pixel circuit and a corresponding multiplexer in accordance with one embodiment of the present disclosure.

FIG. 3 illustrates an operating example of a pixel circuit and a corresponding multiplexer in accordance with one embodiment of the present disclosure.

FIG. 4 illustrates an operating example of a pixel circuit and a corresponding multiplexer in accordance with one embodiment of the present disclosure.

FIG. 5 illustrates signals of a pixel circuit and a corresponding multiplexer in accordance with one embodiment of the present disclosure.

FIG. 6 illustrates a schematic diagram of a pixel circuit and a corresponding multiplexer in accordance with another embodiment of the present disclosure.

FIG. 7 illustrates signals of a pixel circuit and a corresponding multiplexer in accordance with another embodiment of the present disclosure.

### DETAILED DESCRIPTION

Reference will now be made in detail to the present embodiments of the invention, examples of which are illustrated in the accompanying drawings. Wherever possible, the same reference numbers are used in the drawings and the description to refer to the same or like parts.

It will be understood that, in the description herein and throughout the claims that follow, although the terms “first,” “second,” etc. may be used to describe various elements, these elements should not be limited by these terms. These terms are only used to distinguish one element from another. For example, a first element could be termed a second element, and, similarly, a second element could be termed a first element, without departing from the scope of the embodiments.

It will be understood that, in the description herein and throughout the claims that follow, when an element is referred to as being “electrically connected” or “electrically coupled” to another element, it can be directly connected or coupled to the other element or intervening elements may be present. In contrast, when an element is referred to as being “directly connected” or “directly coupled” to another element, there are no intervening elements present. Moreover, “electrically connect” or “connect” can further refer to the interoperation or interaction between two or more elements.

It will be understood that, in the description herein and throughout the claims that follow, the terms “comprise” or “comprising,” “include” or “including,” “have” or “having,” “contain” or “containing” and the like used herein are to be understood to be open-ended, i.e., to mean including but not limited to.

It will be understood that, in the description herein and throughout the claims that follow, the phrase “and/or” includes any and all combinations of one or more of the associated listed items.

It will be understood that, in the description herein and throughout the claims that follow, unless otherwise defined, all terms (including technical and scientific terms) have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Any element in a claim that does not explicitly state “means for” performing a specified function, or “step for” performing a specific function, is not to be interpreted as a “means” or “step” clause as specified in 35 U.S.C. § 112(f). In particular, the use of “step of” in the claims herein is not intended to invoke the provisions of 35 U.S.C. § 112(f).

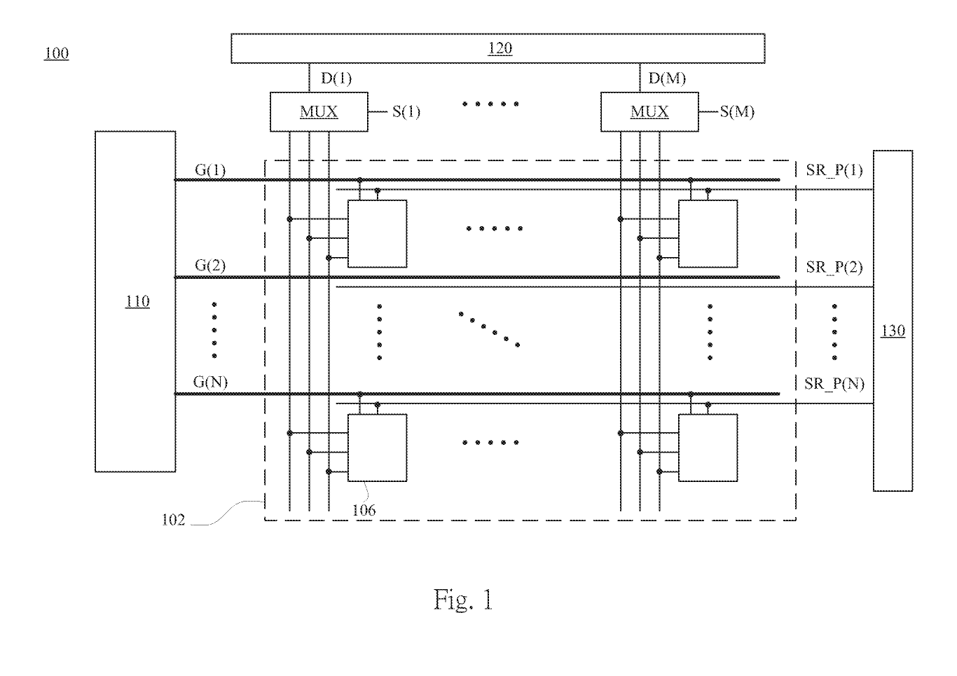

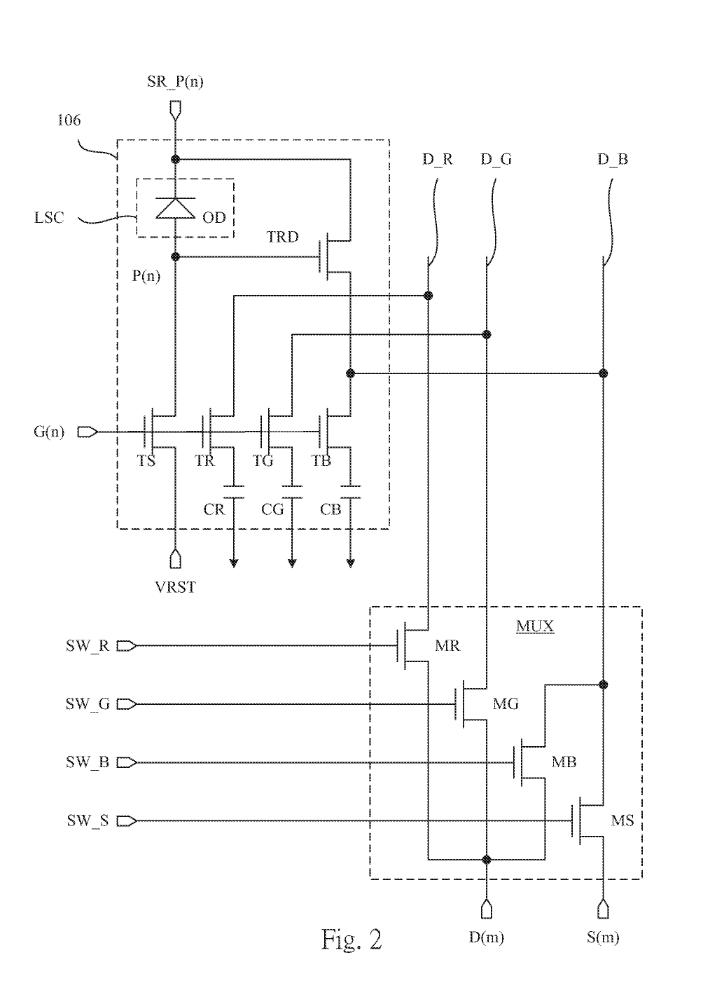

FIG. 1 illustrates a schematic diagram of a display device 100 in accordance with one embodiment of the present disclosure. The display device 100 includes a gate drive circuit 110, a source driver circuit 120, a readout voltage providing circuit 130, multiplexers MUX, and a pixel array 102. The multiplexers MUX are disposed between the pixel array 102 and the source driver circuit 120. The pixel array 102 includes a plurality of the pixel circuits 106 arranged in a matrix. The gate drive circuit 110 is configured to generate a plurality of the gate signals G(1) to G(N) sequentially and provide these gate signals G(1) to G(N) to the pixel circuits 106 of the pixel array 102 to turn on the data switch (e.g., the switches TS, TR, TG, and TB shown in FIG. 2) of the pixel circuits 106 row by row, in which N is a natural number. The source driver circuit 120 is configured to generate a plurality of the data voltages D(1) to D(M), and provide the data voltages D(1) to D(M) to the pixel circuits 106 via the multiplexers MUX to make the pixel circuits 106 display according to the data voltages D(1) to D(M), wherein M is a natural number. Thereby, the display device 100 is able to display images.

The readout voltage providing circuit 130 is configured to generate a plurality of the readout voltages SR_P(1) to SR_P(N) sequentially and provide the readout voltages SR_P(1) to SR_P(N) to the pixel circuits 106 row by row to make the pixel circuits 106 output sensing output signals S(1) to S(M) via the multiplexers MUX. These sensing output signals S(1) to S(M) corresponds to the light sensing procedure of the pixel circuits 106. Details in this regard will be further described in the paragraphs below. In one embodiment, the readout voltage providing circuit 130 and the gate drive circuit 110 are integrated with each other or disposed independently. Besides, in a different embodiment, the pixel circuits 106 have independent readout lines instead of outputting the sensing output signals S(1) to S(M) via the multiplexers MUX.

FIG. 2 illustrates a schematic diagram of the pixel circuit 106 and a corresponding multiplexer MUX in accordance with this embodiment of the present disclosure. In one embodiment, the pixel circuit 106 and the multiplexer MUX are electrically connected with each other via the data lines D_R, D_G, and D_B.

In one embodiment, the multiplexer MUX is configured to provide the data voltage D(m) (e.g., one of the data voltages D(1) to D(M) described previously) to the pixel circuit 106 via the data lines D_R, D_G, and D_B according to the multiplexing signals in a time-division manner. Besides, the multiplexer MUX is also configured to output the sensing output signals S(m) (e.g., one of sensing output signals S(1) to S(M) described previously) from the readout lines corresponding to the switch signal SW_S.

In this embodiment, the readout line can be the data line D_B. In one embodiment, the data line transfers the data voltage D(m) and the sensing output signal S(m) alternatively. In one embodiment, the multiplexer MUX is configured to make the data line D_B selectively be configured to transfer the data voltage D(m) or the sensing output signal S(m) according to the switch signal SW_S.

In this embodiment, the pixel circuit 106 is configured to write the data voltage D(m) from the multiplexer MUX into the corresponding storage capacitor according to the gate signal G(n) (e.g., one of gate signals G(1) to G(N) described previously). Besides, in one embodiment, the pixel circuit 106 is also configured to provide the sensing output signal S(m) to the multiplexer MUX via the data lines D_R, D_G, and D_B according to the readout voltage SR_P(n)(e.g., one of the readout voltages SR_P(1) to S(N) described previously).

In one embodiment, the multiplexer MUX includes the switch MR, MG, MB, and MS. In one embodiment, the pixel circuit 106 includes switches TR, TG, TB, TS, TRD, storage capacitors CR, CG, CB, and a light sensing component LSC. In one embodiment, the light sensing component LSC includes silicon-rich oxide. In one embodiment, the light sensing component LSC can be implemented by a photodiode OD using silicon-rich oxide. However, in a different embodiment, the light sensing also can be implemented by the combination of a common photodiode and a capacitor.

In one embodiment, the first end of the switch MR is electrically connected to the first end of the switch TR via the data line D_R, and the second end of the switch MR is configured to receive the data voltage D(m), and the control end of the switch MR is configured to receive the multiplexing signal SW_R. The switch MR is configured to be turned on according to the multiplexing signal SW_R to provide the data voltage D(m) to the first end of the switch TR via the data line D_R.

In one embodiment, the first end of the switch MG is electrically connected to the first end of the switch TG via the data line D_G, and the second end of the switch MG is configured to receive the data voltage D(m), and the control end of the switch MR is configured to receive the multiplexing signal SW_G. The switch MG is configured to be turned on according to the multiplexing signal SW_G to provide the data voltage D(m) to the first end of the switch TG via the data line D_G.

In one embodiment, the first end of the switch MB is electrically connected to the first end of the switch TB via the data line D_B, and the second end of the switch MB is configured to receive the data voltage D(m), and the control end of the switch MB is configured to receive the multiplexing signal SW_B. The switch MB is configured to be turned on according to the multiplexing signal SW_B to provide the data voltage D(m) to the first end of the switch TB via the data line D_B.

In one embodiment, the first end of the switch MS is electrically connected to the second end of the switch TRD via the data line D_B, and the second end of the switch MS is configured to output the sensing output signal S(m), and the control end of the switch MS is configured to receive the switch signal SW_S. The switch MS is configured to be turned on according to the switch signal SW_S to allow the sensing output signal S(m) from D_B to be outputted through the second end of the switch MS.

In one embodiment, the second end of the switch TR is electrically connected to the storage capacitor CR, and the control end of the switch TR is configured to receive the gate signal G(n). The switch TR is configured to turn on according to the gate signal G(n) to provide the data voltage D(m) to the storage capacitor CR.

In one embodiment, the second end of the switch TG is electrically connected to the storage capacitor CG, and the control end of the switch TG is configured to receive the gate signal G(n). The switch TG is configured to provide the data voltage D(m) according to the gate signal G(n) to the storage capacitor CG.

In one embodiment, the second end of the switch TB is electrically connected to the storage capacitor CB, and the control end of the switch TB is configured to receive the gate signal G(n). The switch TB is configured to provide the data voltage D(m) according to the gate signal G(n) to the storage capacitor CB.

In one embodiment, the anode end of light sensing component LSC (hereinafter referred to as node P(n)) is electrically connected to the first end of the switch TS, and the cathode of the light sensing component LSC is configured to receive the readout voltage SR_P(n). In one embodiment, the light sensing component LSC is configured to generate a sensing voltage at node P(n) according to a light sensing procedure.

In one embodiment, the first end of the switch TRD is configured to receive the readout voltage SR_P(n), the second end of the switch TRD is electrically connected to the data line D_B, and the control end of the switch TS is electrically connected to node P(n). The switch TRD is configured to output the sensing output signal S(m) via the data line D_B according to the sensing voltage on node P(n) and the readout voltage SR_P(n). In one embodiment, the sensing output signal S(m) includes, for example, a sensing output voltage and/or a sensing output current.

In one embodiment, the first end of the switch TS is electrically connected to node P(n), the second end of the switch TS is configured to receive the reset voltage VRST, and the control end of the switch TS is configured to receive the gate signal G(n) as a reset control signal. The switch TS is configured to be turned on according to the gate signal G(n) to provide the reset voltage VRST to node P(n). It should be noted that, in a different embodiment, the control end of the switch TS can receive a reset control signal which is different from the gate signal G(n), and therefore, the present disclosure is not limited to the examples described herein.

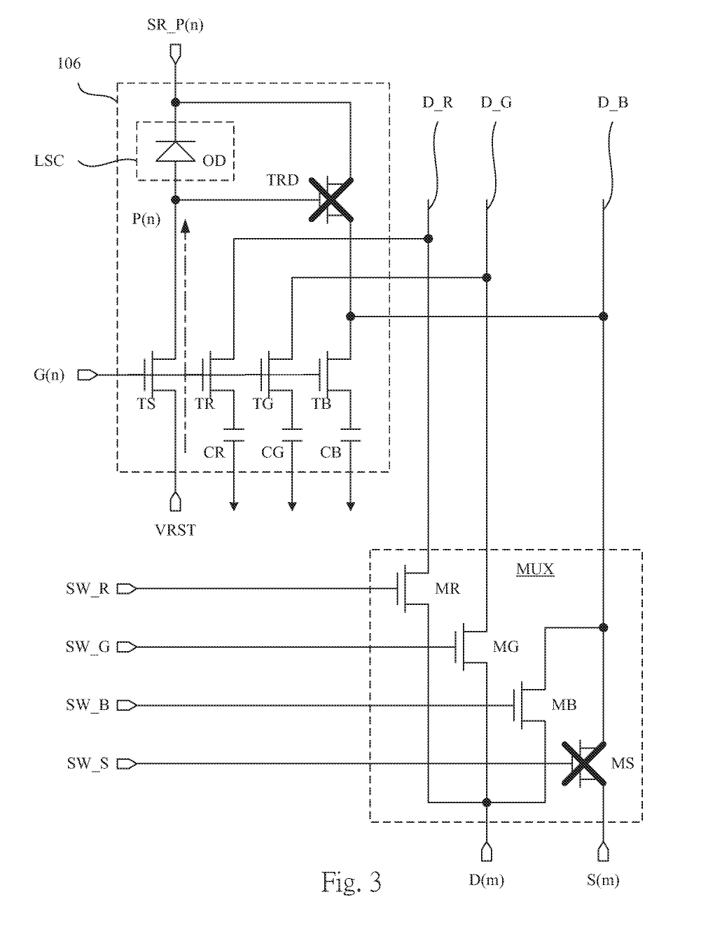

In the paragraphs below, operations of the pixel circuit 106 and multiplexer MUX corresponding thereto in an operative embodiment will be described with reference to FIG. 3 to FIG. 5. However, the present disclosure is not limited to the embodiment below.

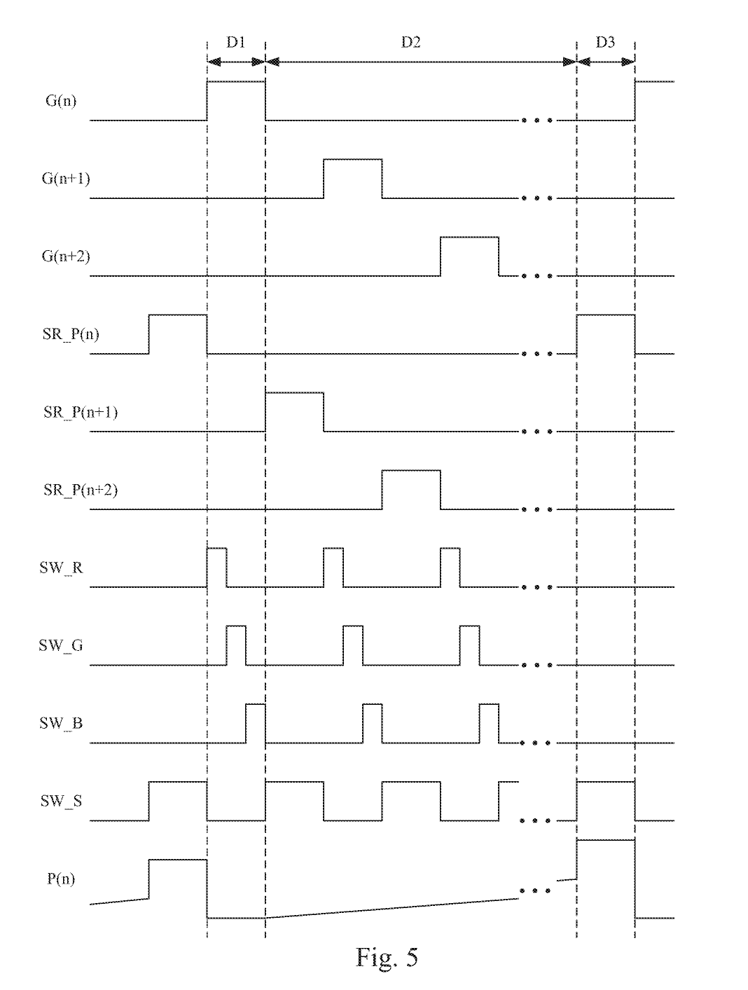

Referring to both FIG. 3 and FIG. 5, during the period D1, the gate signal G(n) has a first voltage level (e.g. high voltage level), the switch signal SW_S has a second voltage level (e.g. low voltage level), and the readout voltage SR_P(n) has the second voltage level (e.g. low voltage level). At this time, the switches TR, TG, and TB are turned on according to the gate signal G(n) to sequentially write the data voltage D(m) into the storage capacitors CR, CG, and CB corresponding to the multiplexing signals SW_R, SW_G, and SW_B at different time periods.

At this time, the switch TS is turned on to provide the reset voltage VRST to node P(n) according to the gate signal G(n). At this time, the switch TRD is turned off according to the reset voltage VRST at node P(n). At this time, the switch MS is turned off according to the switch signal SW_S to prevent the data voltage D(m) of the second output data line D_B of the switch MS to be served as the sensing output signal S(m).

During the period D2, the gate signal G(n) has the second voltage level (e.g. low voltage level), and the readout SR_P(n) has the second voltage level (e.g. low voltage level). At this time, the switches TR, TG, TB, and TS are turned off according to the gate signal G(n). At this time, the light sensing component LSC starts the light sensing procedure to charge or discharge node P(n) to generate the sensing voltage.

For example, at the beginning of the period D2, the node P(n) has a reset voltage VRST (e.g. −8V). Then, during the period D2, a leakage current of the light sensing component LSC is caused by sensation of light to make the readout voltage SR_P(n) with the second voltage level (e.g. 0V) charge node P(n) by the leakage current. At the end of the period D2, the voltage on node P(n) is taken as the sensing voltage generated by the light sensing component LSC during the period D2 described above.

During the period D2, by designing the reset voltage VRST and the second voltage level of the readout voltage SR_P(n), the voltage on the node P(n) can be smaller than the threshold voltage of the switch TRD, so that the switch TRD is turned off during the period D2 to prevent from outputting the sensing output signal S(m).

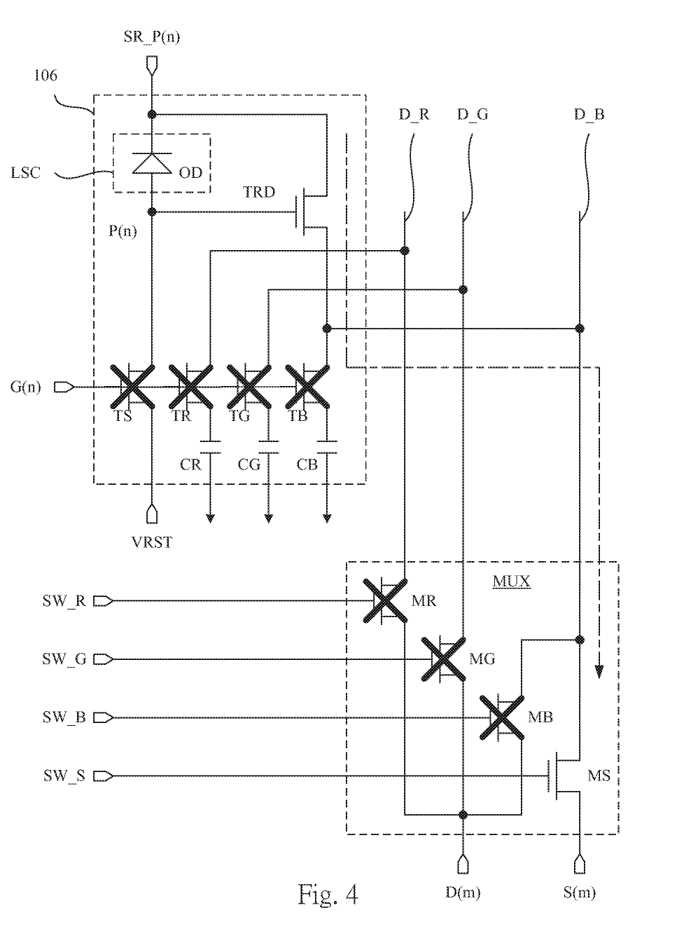

Referring to both FIG. 4 and FIG. 5, during the period D3, the gate signal G(n) has the second voltage level (e.g. low voltage level), the switch signal SW_S has the first voltage level (e.g. high voltage level), and the readout voltage SR_P(n) has the first voltage level (e.g. high voltage level). At this time, the switches TR, TG, TB, and TS are turned off according to the gate signal G(n).

At this time, due to the coupling effect of the light sensing component LSC, the sensing voltage on node P(n) changes corresponding to the variation of the readout voltage SR_P(n), so that the switch TRD generates the sensing output signal S(m) and provides the sensing output signal S(m) to the switch MS according to the readout voltage SR_P(n) and the changed sensing voltage.

For example, during the end of the period D2, the sensing voltage of the node P(n) is −2.5V. When the readout voltage SR_P(n) changes from the second voltage level (e.g. 0V) to the first voltage level (e.g. 8.5V), the sensing voltage of the node P(n) correspondingly changes to 6V (e.g. −2.5V+8.5V) to make the switch TRD provide the sensing output signal S(m) accordingly.

At this time, the switch MS is turned on according to the switch signal SW_S to output the sensing signal S(m).

Through the configuration above, the pixel circuit 106 can perform the writing operation of the data voltage D(m) and the reset operation of the node P(n) during the period D1, so as to integrate the display operation and the light sensing operation of the pixel circuit.

Besides, through the configuration above, the sensing output signal S(m) can be read out by the data line D_B without disposing additional readout line, so that the aperture ratio of the display device 100 can be increased.

It should be noted, in different embodiments, an independent readout line can also be disposed for outputting the sensing output signal S(m), and the present disclosure is not limited to the examples described above. In such an embodiment, the switch MS can also be omitted.

Additionally, although the pixel circuit 106 having 3 data switches TR, TG, TB and 3 storage capacitors CR, CG, CB is taken as a descriptive example above, in different embodiments, the number of the data switches and the storage capacitors in the pixel circuit 106 can be varied according to the actual requirements, and the number of the multiplexer MUX also can be varied accordingly. In some embodiments, the pixel circuit 106 may have only one data switch and one storage capacitor. In this embodiment, all of the switches MR, MG, and MB of the multiplexer MUX can be omitted.

Furthermore, although the sensing output signal S(m) outputted via the data line D_B is taken as a descriptive example above, in different embodiments, the sensing output signal S(m) also can be read out via the data line D_R or the data line D_G, and therefore, the present disclosure is not limited to the examples described above.

Furthermore, although the first end of the switch TRD receiving the readout voltage SR_P(n) is taken as a descriptive example above, in different embodiments, the first end of the switch TRD can receive a supply voltage different from the readout voltage SR_P(n), and the switch TRD can output the sensing output signal S(m) according to this supply voltage. Therefore, the present disclosure is not limited to the examples described above.

Furthermore, in some embodiments, the second end of the switch TS can receive gate signals of other stages (e.g. gate signals G(n+1), G(n+2)) and take the second voltage level of other stages (e.g. low voltage level) as the reset voltage VRST, so that of the number of signal lines can be decreased.

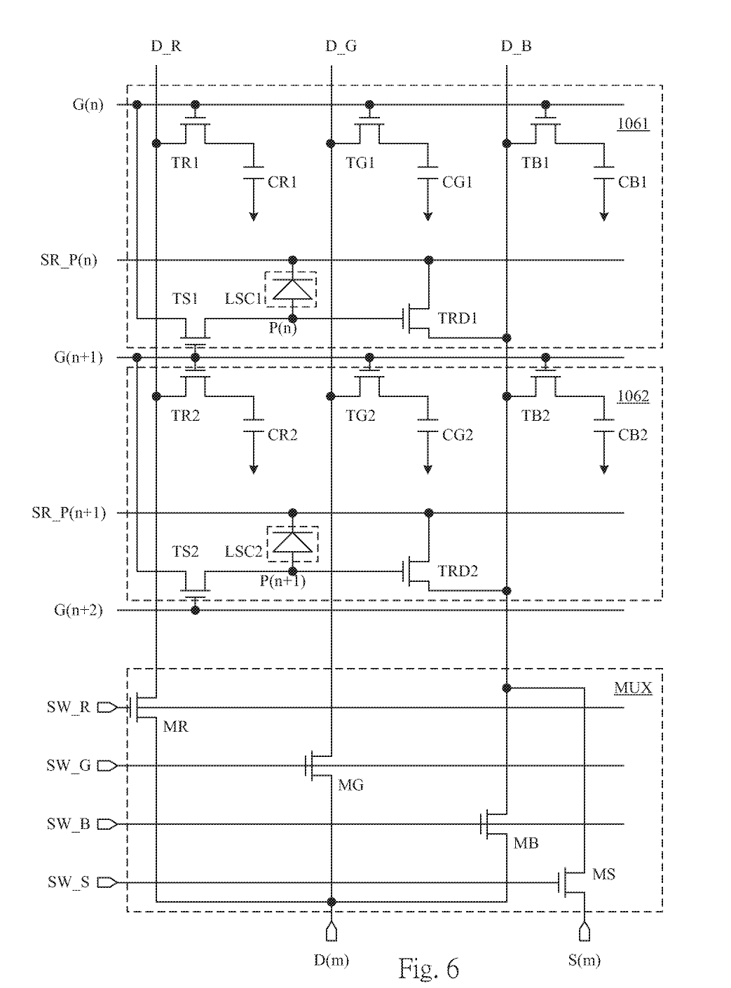

FIG. 6 illustrates a schematic diagram of the pixel circuits 1061, 1062, and a corresponding multiplexer MUX in accordance with one embodiment of the present disclosure. In some embodiments, the pixel circuits 1061, 1062 can replace the pixel circuits 106 described previously. In this embodiment, the structures of the pixel circuits 1061, 1062 are similar to the structures of the pixel circuits 106, and therefore, many aspects that are similar will not be described herein.

In this embodiment, the switches TR1, TG1, TB1, and TS1 of the pixel circuit 1061 receive different gate signals separately. In one embodiment, the control ends of the switches TR1, TG1, and TB1 of the pixel circuit 1061 are configured to receive the gate signal G(n), and the control end of the switch TS1 is configured to receive the gate signal G(n+1) as the reset control signal.

On the other hand, the second end of the switch TS1 is configured to receive the gate signal G(n) as the reset voltage RST.

Similarly, in this embodiment, the switches TR2, TG2, TB2, and TS2 of the pixel circuit 1062 receive different gate signals separately. In one embodiment, the control ends of the switches TR2, TG2, and TB2 of the pixel circuit 1062 are configured to receive the gate signal G(n+1), and the control end of the switch TS2 is configured to receive the gate signal G(n+2) as the reset control signal.

On the other hand, the second end of the switch TS2 is configured to receive the gate signal G(n+1) as the reset voltage RST.

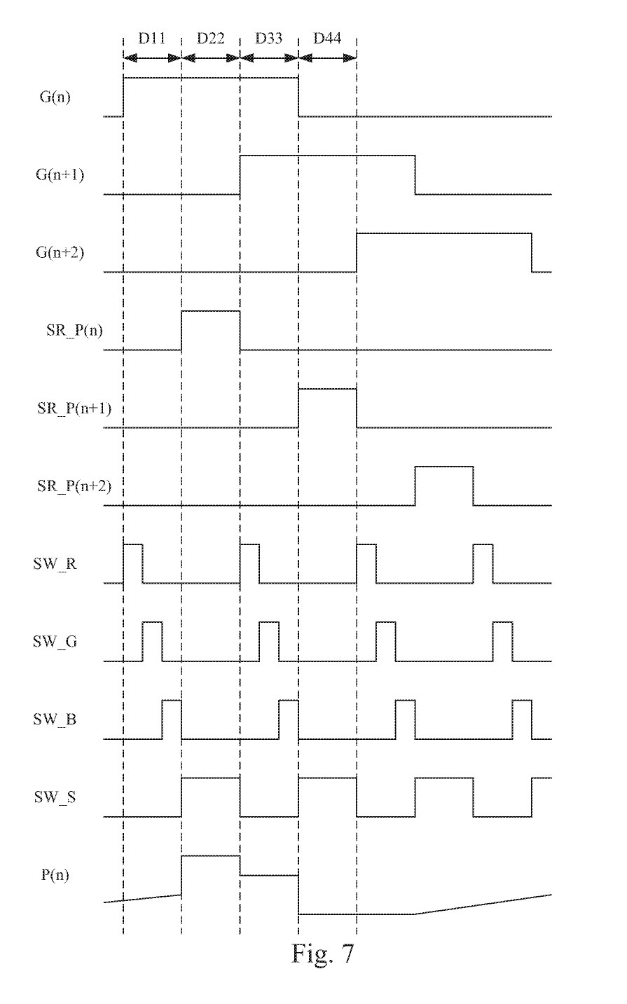

In the paragraphs below, operations of the pixel circuits 1061, 1062 and the multiplexer MUX corresponding thereof in an operative embodiment will be described with reference to FIG. 6 to FIG. 7. However, the present disclosure is not limited to the embodiment below.

During the period D11, the gate signal G(n) has the first voltage level (e.g. high voltage level), and the gate signals G(n+1), G(n+2) have the second voltage levels (e.g. low voltage levels), and the switch signal SW_S has the second voltage level (e.g. low voltage level), and the readout voltages SR_P(n), SR_P(n+1), and SR_P(n+2) have the second voltage levels (e.g. low voltage level). At this time, the switches TR1, TG1, and TB1 are turned on according to the gate signal G(n) to write the data voltage D(m) into the storage capacitors CR1, CG1, and CB1 sequentially corresponding to the multiplexing signals SW_R, SW_G, and SW_B at different time periods to perform a pre-charge operation.

At this time, the switch TS1 is turned off according to the gate signal G(n+1). At this time, the switch MS is turned off according to the switch signal SW_S to prevent the second end of the switch MS from outputting the data voltage D(m) of the data line D_B to serve as the sensing output signal S(m).

During the period D22, the gate signal G(n) has the first voltage level (e.g. high voltage level), and the gate signals G(n+1), G(n+2) have the second voltage levels (e.g. low voltage levels), and the switch signal SW_S has the first voltage level (e.g. high voltage level), and the readout voltages SR_P(n+1), SR_P(n+2) have the second voltage levels (e.g. low voltage levels).

At this time, the switch TS1 is turned off according to the gate signal G(n+1). At this time, due to the coupling effect of the light sensing component LSC1, the sensing voltage on node P(n) changes corresponding to the variation of the readout voltage SR_P(n), so that the switch TRD1 generates the sensing output signal S(m) and provides the sensing output signal S(m) to the switch MS according to the changed sensing voltage. At this time, the switch MS is turned on according to the switch signal SW_S to output the sensing output signal S(m). Details of these operations can be ascertained by referring to the paragraphs above; therefore, a description in this regard will not be repeated herein.

During the period D33, the gate signals G(n), G(n+1) have the first voltage levels (e.g. high voltage levels), and the gate signal G(n+2) has the second voltage level (e.g. low voltage level), and the switch signal SW_S has the second voltage level (e.g. low voltage level), and the readout voltages SR_P(n), SR_P(n+1), and SR_P(n+2) have the second voltage levels (e.g. low voltage levels).

At this time, the switches TR1, TG1, and TB1 are turned on according to the gate signal G(n) to write the data voltage D(m) into the storage capacitors CR1, CG1, and CB1 sequentially corresponding to the multiplexing signals SW_R, SW_G, and SW_B at different time periods. On the other hand, the switches TR2, TG2, and TB2 are turned on according to the gate signal G(n+1) to write the data voltage D(m) into the storage capacitors CR2, CG2, and CB2 sequentially corresponding to the multiplexing signals SW_R, SW_G, and SW_B at different time periods to perform a pre-charge operation.

At this time, the switch TS1 is turned on according to the gate signal G(n+1) to provide the first voltage level (e.g. high voltage level) to the nodes P(n). At this time, the switch TS2 is turned off according to the gate signal G(n+2).

At this time, the switch MS is turned off according to the switch signal SW_S to prevent the second end of the switch MS from outputting the data voltage D(m) on the data line D_B to serve as the sensing output signal S(m).

During the period D44, the gate signal G(n+1) has the first voltage level (e.g. high voltage level), and the gate signals G(n), G(n+2) have the second voltage levels (e.g. low voltage levels), and the switch signal SW_S has the first voltage level (e.g. high voltage level), and the readout voltage SR_P(n+1) has the second voltage level (e.g. low voltage level).

At this time, the switches TS1, TG1, and TB1 are turned off according to the gate signal G(n+1) to prevent the data voltage D(m) from being written into the storage capacitors CR1, CG1, and CB1.

At this time, the switch TS1 is turned on according to the gate signal G(n+1) to provide the second voltage level (e.g. low voltage level) to the node P(n) as the reset voltage.

At this time, due to the coupling effect of the light sensing component LSC2, the sensing voltage of node P(n+1) changes corresponding to the variation of the readout voltage SR_P(n+1), and the switch TRD2 generates the sensing output signal S(m) and provides the sensing output signal S(m) to the switch MS according to the changed sensing voltage. At this time, the switch MS is turned on according to the switch signal SW_S to output the sensing output signal S(m). Details of these operations can be ascertained by referring to the aforementioned paragraphs; therefore, a description in this regard mentioned previously will not be repeated herein.

The subsequent operations of this operative embodiment can be deduced according to the abovementioned operations. Therefore, details in this regard will not be described herein.

Through the above operations, the storage capacitors CR1, CG1, and CB1 can be pre-charged during the period D11, and the storage capacitors CR2, CG2, and CB2 can be pre-charged during the period D33 to ensure sufficient charging time of the capacitors.

Details and variants of such an operative embodiment can be ascertained with reference to the paragraph described above, and a description in this regard will not be repeated herein.

Although the present invention has been described in considerable detail with reference to certain embodiments thereof, other embodiments are possible. Therefore, the scope of the appended claims should not be limited to the description of the embodiments contained herein. cm What is claimed is:

1. A pixel circuit comprising:
one or more storage capacitors;
one or more first switches electrically connected to the storage capacitors and configured to provide a data voltage to the one or more storage capacitor according to a gate signal;
a light sensing component for generating a sensing voltage according to a light sensing procedure;
a second switch electrically connected to the light sensing component and configured to output a sensing output signal according to the sensing voltage; and
a third switch electrically connected to the light sensing component and configured to provide a reset voltage to the light sensing component according to a reset control signal.

2. The pixel circuit as claimed in claim 1, wherein the one or more first switches are electrically connected to one or more data lines, and the one or more data lines are configured to selectively transmit the data voltage and the sensing output signal.

3. The pixel circuit as claimed in claim 2, wherein one of the one or more data lines alternately transmits the data voltage and the sensing output signal.

4. The pixel circuit as claimed in claim 2, wherein one of the one or more data lines is electrically connected to a multiplexer, and the multiplexer is configured to selectively make the one of the one or more data lines be configured to transmit the data voltage and the sensing output signal according to a switching signal.

5. The pixel circuit as claimed in claim 1, wherein a first end of the second switch is electrically connected to a cathode end of the light sensing component, a second end of the second switch is electrically connected to one of the one or more first switch, and a control end of the second switch is electrically connected to an anode end of the light sensing component.

6. The pixel circuit as claimed in claim 1, wherein the second switch is configured to output the sensing output signal according to a readout voltage provided to a cathode end of the light sensing component and the sensing voltage.

7. The pixel circuit as claimed in claim 1, wherein during a first stage, the one or more first switches are turned on to provide the data voltage to the one or more storage capacitors, and the third switch is turned on to provide the reset voltage to an anode end of the light sensing component to make the second switch turn off according to the reset voltage.

8. The pixel circuit as claimed in claim 1, wherein during a second stage, the one or more first switches, the second switch, and the third switch are turned off, and the light sensing component is configured to charge or discharge an anode end of the light sensing component according to the light sensing procedure to generate the sensing voltage.

9. The pixel circuit as claimed in claim 1, wherein during a third stage, a cathode end of the light sensing component receive a readout voltage to change the sensing voltage on an anode end of the light sensing component, and the second switch generates the sensing output signal according to the changed sensing voltage.

10. The pixel circuit as claimed in claim 1, wherein the light sensing component comprises silicon-rich oxide, and wherein the reset control signal is the gate signal.

11. The display device, comprising:
one or more storage capacitors;
one or more data lines;
one or more first switches, wherein one or more first end of the one or more first switches are electrically connected to the one or more data lines, one or more second end of the one or more first switches are electrically connected to the one or more storage capacitors, and one or more control end of the one or more first switches are configured to receive a gate signal;
a light sensing component;
a second switch, wherein a first end of the second switch is electrically connected to an anode end of the light sensing component, a second end of the second switch is configured to receive a reset voltage, and a control end of the second switch is configured to receive a reset control voltage; and
a third switch, wherein a first end of the third switch is electrically connected to a readout line, a control end of the third switch is electrically connected to the anode end of the light sensing component, and the third switch is configured to output a sensing output signal via the readout line according to a sensing voltage on the anode end of the light sensing component.

12. The display device as claimed in claim 11, wherein the readout line is one of the one or more data lines.

13. The display device as claimed in claim 11, wherein the readout line transmits a data voltage to one of the first switches and transmits the sensing output signal, alternately.

14. The display device as claimed in claim 13, further comprising:
a multiplexer electrically connected to the readout line and configured to make the readout line selectively transmit the data voltage and the sensing output signal according to a switching signal.

15. The display device as claimed in claim 11, wherein a second end of the third switch is electrically connected to a cathode end of the light sensing component, and the third switch is configured to output the sensing output signal according to a readout voltage provided to a cathode end of the light sensing component and the sensing voltage.

16. The display device as claimed in claim 11, wherein a first end of the third switch is configured to receive a supply voltage, and the second switch is configured to output the sensing output signal according to the sensing voltage and the supply voltage.

17. The display device as claimed in claim 11, wherein during a first stage, the one or more first switches are turned on to provide a data voltage to the one or more storage capacitors, and the second switch is turned on to provide the reset voltage to an anode end of the light sensing component to make the third switch turn off according to the reset voltage.

18. The display device as claimed in claim 17, wherein during a second stage after the first stage, the one or more first switches, the second switch, and the third switch are turned off, and the light sensing component is configured to charge or discharge an anode end of the light sensing component according to a light sensing procedure to generate the sensing voltage.

19. The display device as claimed in claim 18, wherein during a third stage after the second stage, a cathode end of the light sensing component receive a readout voltage to change the sensing voltage of an anode end on the light sensing component, and the third switch generates the sensing output signal according to the changed sensing voltage.

20. The display device as claimed in claim 11, wherein the light sensing component comprises silicon-rich oxide, and wherein the reset control signal is the gate signal.
